(19) United States
(12) Patent Application Publication
(10) Pub. No.: US 2017/0172082 A1
(43) Pub. Date: Jun. 22, 2017

(54) GROWING MEDIA FOR PLANTS

(71) Applicant: Replantable LLC, Atlanta, GA (US)

(72) Inventors: Alexander Weiss, Atlanta, GA (US); Ruwan Subasinghe, Atlanta, GA (US)

(21) Appl. No.: 15/382,247

(22) Filed: Dec. 16, 2016

Related U.S. Application Data
(60) Provisional application No. 62/269,605, filed on Dec. 18, 2015.
(60) Provisional application No. 62/379,010, filed on Aug. 24, 2016.

(51) Int. Cl. A01G 31/00; A01G 31/06

(52) U.S. Cl. CPC A01G 31/001; A01G 31/06; A01G 2031/007

(57) ABSTRACT

The present disclosure describes a hydroponic system. The hydroponic system can include a pad medium that includes a plurality of seeds. The pad medium can be supported over a water vessel by a support medium. The system can also include a first nutrient strip that can be coupled to the pad medium, support medium, or vessel. The nutrient strip can include a first nutrient pad that is impregnated with nutrients. The nutrient strip can also include a barrier layer that at least partially encloses the nutrient pad. The barrier layer can include an opening to expose the nutrient pad to an external environment. A shape of the nutrient pad and a shape of the opening can be configured to control a rate of release of nutrients from the nutrient strip.

### CROSS-REFERENCE TO RELATED APPLICATIONS

This application claims priority to U.S. Provisional Patent Application No. 62/269,605 filed on Dec. 18, 2015 and to U.S. Provisional Patent Application No. 62/379,010 filed on Aug. 24, 2016. The contents of each of the foregoing applications are herein incorporated by reference in their entirety.

### BACKGROUND

The purpose of growing media is to provide support for a plant while it grows. A commonly used growing medium is soil. Soil has several shortcomings in the context of urban agriculture. It must be manually replenished with nutrients in the form of organic matter or other fertilizer. These methods of fertilization require moving heavy and bulky materials which is not ideal for distributed farming in the urban environment. In addition, the fertilization of soil requires a large amount of manual labor, tools, equipment, and cleaning of those tools and equipment. Another disadvantage of soil is its ability to harbor pests and pathogens. These pests can destroy crops and spread disease, and soil-borne pathogens are responsible for thousands of deaths worldwide.

Achieving the proper level of aeration of the soil is a difficult facet of soil-based growing. This is traditionally controlled by careful watering of the soil. If over- or under-watered, soil can become a poor environment for the growth of plants.

### SUMMARY OF THE DISCLOSURE

According to one aspect of the disclosure, a hydroponic system includes a pad medium that includes a plurality of seeds. The system can also include a first nutrient strip that is coupled to the pad medium. The nutrient strip can include a first nutrient pad that is impregnated with nutrients. The system first nutrient strip can include a barrier layer that at least partially encloses the nutrient pad. The barrier layer can have an opening to expose the nutrient pad to an external environment. The shape of the nutrient pad and the shape of the opening can be configured to control a rate of release of nutrients from the nutrient strip.

In some implementations, the system can also include a vessel and a support medium. The support medium can include a plurality of openings to enable roots from the plurality of seeds to pass through the support medium and into the vessel. In some implementations, the plurality of openings can include a non-linear form that cause the roots from the plurality of seeds to change direction as they pass through the support medium and into the vessel.

In some implementations, the shape of the nutrient pad changes over a length of the nutrient strip. The nutrient pad can include one of a woven material, a polylactic acid non-woven material, a polypropylene non-woven material, or a natural fiber non-woven material. The nutrient pad can include a dried gel that includes at least one of corn starch, rice starch, potato starch, agar, gum arabic, guar gum, and psyllium. The nutrients can be dissolved in the gel.

The system can include a second nutrient strip that can include a second nutrient pad that is impregnated with nutrients that are different than the nutrients of the first nutrient pad.

The nutrients can include at least one of a water-soluble fertilizer and support chemicals. The support chemicals can include silicon or pH regulating chemicals. The nutrient strip can be configured to release the nutrients to the external environment after the seeds substantially exhaust the nutrients stored in an endosperm of each of the plurality of seeds. In some implementations, a cross-sectional area of the nutrient pad changes along the length of the nutrient pad.

According to another aspect of the disclosure, a method for manufacturing a hydroponic system can include forming a pad medium. The pad medium can be formed by depositing a plurality of seeds onto a base layer. Forming the pad medium can also include depositing a top layer on the base layer and the plurality of seeds. The method can also include forming a first nutrient pad into a shape that is configured to control a rate of release of nutrients from the first nutrient pad. The method can include exposing a first nutrient pad to a nutrient solution. The method can include at least partially enclosing the first nutrient pad in a barrier layer. The first nutrient pad can be coupled to the pad medium. The method can include forming at least one opening in the barrier layer to expose a portion of the first nutrient pad to an external environment. A shape of the at least one opening can be configured to control the rate of release of nutrients from the first nutrient pad.

The method can also include forming a support medium. The support medium can include a plurality of openings that enable roots from the plurality of seeds to pass through the support medium and into the vessel. In some implementations, the plurality of openings can include a non-linear form that cause the roots from the plurality of seeds to change direction as they pass through the support medium and into the vessel.

In some implementations, the shape of the nutrient pad changes over a length of the nutrient strip. The nutrient pad can include one of a woven material, a polylactic acid non-woven material, a polypropylene non-woven material, or a natural fiber non-woven material. The nutrient pad can include a dried gel that can include at least one of corn starch, rice starch, potato starch, agar, gum arabic, guar gum, and psyllium. The nutrients can be dissolved in the gel.

In some implementations, the method can include forming a second nutrient pad. The method can also include exposing the second nutrient pad to a second nutrient solution that is different from the nutrient solution. The second nutrient pad can be coupled to the pad medium.

The nutrients can include at least one of a water-soluble fertilizer and support chemicals. The support chemicals can include at least one of silicon or pH regulating chemicals. The method can also include compressing the pad medium. In some implementations, a cross-sectional area of the nutrient pad changes along the length of the nutrient pad.

The foregoing general description and following description of the drawings and detailed description are exemplary and explanatory and are intended to provide further explanation of the invention as claimed. Other objects, advantages, and novel features will be readily apparent to those skilled in the art from the following brief description of the drawings and detailed description of the invention.

### BRIEF DESCRIPTION OF THE DRAWINGS

The skilled artisan will understand that the figures, described herein, are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various drawings. The drawings are not necessarily to scale; emphasis instead being placed upon illustrating the principles of the teachings. The drawings are not intended to limit the scope of the present teachings in any way. The system and method may be better understood from the following illustrative description with reference to the following drawings in which:

FIG. 1 illustrates an example hydroponic system.

FIG. 2A illustrates an exploded view of an example pad medium for use in the system illustrated in FIG. 1.

FIG. 2B illustrates a cross-section of an example pad medium for use in the system illustrated in FIG. 1.

FIGS. 3A-3H illustrate examples of the support medium for use in the system illustrated in FIG. 1.

FIG. 4A illustrates a top view of an example nutrient strip for use in the system illustrated in FIG. 1.

FIG. 4B illustrates a cross-sectional view of the example nutrient strip illustrated in FIG. 4A.

FIGS. 5A-5D illustrate example configurations of the nutrient strip for use in the system illustrated in FIG. 1.

FIG. 6 illustrates an example method for manufacturing the system illustrated in FIG. 1.

FIGS. 7A-7C illustrate plots that showing example effects of nutrient strip configurations on nutrient release rates.

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes.

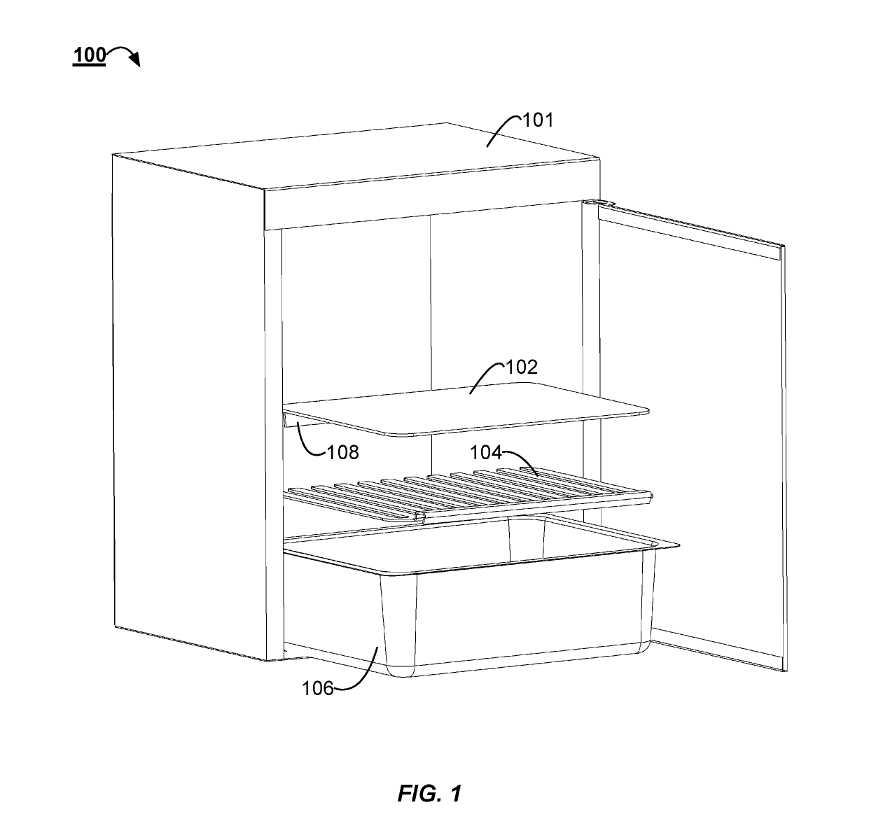

FIG. 1 illustrates an example hydroponic system 100. The system 100 includes a pad medium 102. The pad medium 102 is supported over a vessel 106 by a support medium 104. The system 100 also includes a nutrient strip 108. The system 100 can be housed within an incubator 101. The incubator 101 can be an enclosed container that can house the system 100. The interior environment of the incubator 101 can be controller. For example, the incubator 101 can include a controller and grow lights. The controller can control the amount and duration of light exposed to the system 100. In some implementations, the controller can also regulate the temperature and humidity within the incubator.

As an overview, the pad medium 102 can contain seeds, one or more water-absorbent layers, one or more layers impregnated with nutrients, and one or more waterproof layers. In some implementations, the layers of the pad medium 102 are not waterproof but slow the rate of evaporation of a liquid from the vessel 106. The pad medium 102 can serve as a carrier for the seeds and nutrients, while holding water to hydrate the seeds. The support medium 104 can be a durable and easy to clean material, such as stainless steel, aluminum, or plastic. The support medium 104 can support the pad medium 102 over the vessel 106, and can resist bending moments and downward force applied by the plants via the pad medium 102. In some implementations, the support medium 104 is reusable, and in other implementations the support medium 104 is disposed after a use. In some implementations, the support medium 104 can also provide support to the roots of the plants as they develop in the pad medium 102. The vessel 106 is supplied with water to hydrate the seeds and pad medium 102. As described below, the nutrient strip 108 releases nutrients into the water stored in the vessel 106 at a predetermined diffusion rate.

Continuing the overview, the vessel 106 can be filled with water, which can enter the pad medium 102. This water hydrates the seeds within the pad medium 102. When the seeds have germinated, the shoots of the plant exit the top of the pad medium 102 and the roots exit the bottom of the pad medium 102. Perforations or other openings in the support medium 104 enable the roots to pass through the support medium 104 and enter the water stored in the vessel 106. Over time, the nutrient strip 108 releases nutrients into the water, which is consumed by the plant. As the plant consumes the water (and as evaporation occurs), the water level drops in the tray. The airspace above the water serves to aerate the roots.

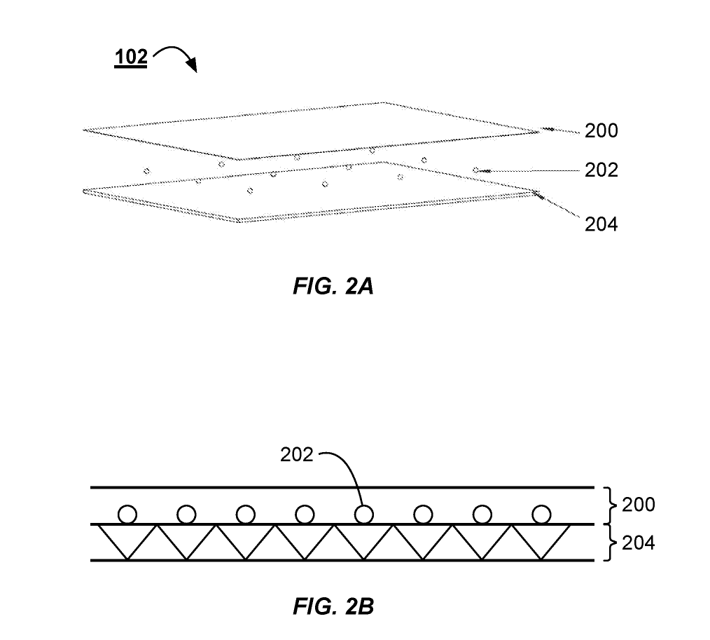

FIG. 2A illustrates an exploded view of an example of the pad medium 102. FIG. 2B illustrates a cross-section of the example pad medium 102. The pad medium 102 includes a top layer 200 and a base layer 204. The seeds 202 are positioned between the top layer 200 and the base layer 204. In some implementations, the seeds 202 are positioned within the top layer 202 or the base layer 204. As illustrated in FIG. 2B, the base layer 204 can be corrugated to provide structural support for the pad medium 102. In some implementations, the base layer 204 is capable of supporting the pad medium 102 without the use of the support medium 104. In some implementations, the base layer 204 can be soaked in a nutrient solution and subsequently dried to impregnate the base layer 204 with the nutrients. Upon wetting the base layer 204, the dried nutrients can be released. In some implementations, impregnating the base layer 204 can result in quicker release rates, which can last for shorter periods or time, when compared to the use of the nutrient strip 108. In some implementations, the pad medium 102 can include multiple top layers 200. For example, the seeds 202 can be sandwiched between a first and second top layer 200.

The base layer 204 is permeable to the plant's roots. In some implementations, the base layer 204 is made permeable by including a porous structure. In other implementations, the strength of the base layer 204 is low enough such that the plant's roots can penetrate the base layer 204. In some implementations, the base layer 204 can include woven or non-woven textiles, pressed or un-pressed pulp, foams, sponges, paper, a mixture of organic material bound together with a binder, or any combination thereof. Example woven textiles can include, but are not limited to, burlap, cloth, linen, gauze, or natural fibers (e.g., coconut coir or jute fibers). The pore size or spacing of the weave is configured such that the roots can penetrate the woven textiles by infiltrating the spaces between the fibers that make up the material of the base layer 204. In some implementations, the base layer 204 can include non-woven textiles that can be manufactured using processes such as air-laying, carding, hydroentanglement, needle punching, wet-laying, spin binding, and melt blowing. The non-woven material can be bound mechanically, thermally, or with an adhesive. With adhesive binding, the adhesive is configured to not dissolve in water for a duration of at least 60 days and to not release dissolved solids that would interfere with the osmotic pressure gradient of the germinating seed and prevent germination. In some implementations, the non-woven material is biodegradable, such as polylactic acid (PLA). In some implementations, the non-woven material can include natural fibers, such as coconut coir or jute, which can be bound by a latex binder or a starch-based binder. In some implementations, the base layer 204 can include pulp, either virgin or recycled. The pulp can be from the pulps of wood, straw, bagasse, or other plants. The base layer 204 can also include expanded polystyrene foam or a cellulose sponge. In some implementations, the base layer 204 can include organic matter such as soil, peat, coconut coir, and other particles and fibers bound together with a binder such as starch, guar gum, agar agar, gum arabic, xanthan gum, psyllium, or a polymeric binder.

In some implementations, the base layer 204 includes paper. Paper can have a higher wet-strength when compared to pulp. The strength of the paper can be controlled by the setting the paper's thickness. In some implementations, the paper is perforated (or pores are otherwise generated in the paper) to enable the plant root to pass through the base layer 204. The perforation can be made using pinned rollers, which can continuously perforate a web of paper. Another option is to use filter paper, which has been either been perforated chemically (mercerized), by mechanical action such as crêping, or by contact with stiff metal bristles. Crêped paper and mercerized paper can both have small perforations that allow roots to penetrate. In some implementations, the paper is perforated by laser perforation. In some implementations, a plurality of layers of paper are used to construct the base layer 204. For example, as illustrated in FIG. 2B, a top layer and a bottom layer of paper can be separated by a corrugated sheet. Each layer can be perforated or the entire base layer 204 can be perforated after assembly.

Referring to FIGS. 2A and 2B, the pad medium 102 also includes the top layer 200. The top layer 200 is configured to enable the sprouting seeds to penetrate the top layer 200. In some implementations, the plant's shoot is larger than the seed. In these implementations, a pore large enough to allow the shoot through the top layer 200 would also enable the seed to fall out during transport. The top layer 200 can be configured to be weak enough to enable the shoot to move and penetrate through material of the top layer 200.

In some implementations, the top layer 200 can include sheets of polyvinyl alcohol or other biodegradable polymers. The materials of the top layer 200 can absorb water, and eventually dissolve in water, allowing the shoot to grow upward. The top layer 200 can include dried gels. In some implementations, dried gels can have high a strength to hold the seeds in place, but when wet, the gel can swell and assist in seed hydration while providing an easily penetrable barrier for the shoots. The gels can include corn starch, potato starch, rice starch, xanthan gum, gum arabic, agar agar, guar gum, the ground mucilloid coating of various seeds, psyllium, or any combination thereof. In some implementations, the gel can include additives to control algae and mold. To control algae, algicides such as grapefruit seed extract can be added to the gel. In some implementations, a colorant can be used to make the gel opaque or semi-opaque to light to control algal growth. To control mold, mold inhibitors such as tea tree oil, mint essential oil, or potassium sorbate can be added to the gel. In some implementations, the top layer 200 can include pulp, which when wet, enables the shoots to penetrate the pulp by moving aside pulp clumps. The pulp also holds water and can assist in germination of the seeds. In some implementations, the top layer 200 can include thin sheets of paper that are weak enough for the shoot to break through the paper.

Referring to FIGS. 2A and 2B, the pad medium 102 also includes a plurality of seeds 202. The seeds 202 may be deposited on the base layer 204 in a pattern or randomly. When patterned randomly, the seeds can be deposited with a specific density of seeds per surface area. The method of seed deposition is discussed below. Random dispersion of the seeds can be used for smaller plants such as arugula, and plants not being grown to maturity such as microgreens. Patterning the seeds can be used for larger plants like heads of lettuce or kale. Patterning the seeds can prevent the plants from growing too close to each other and competing with one another.

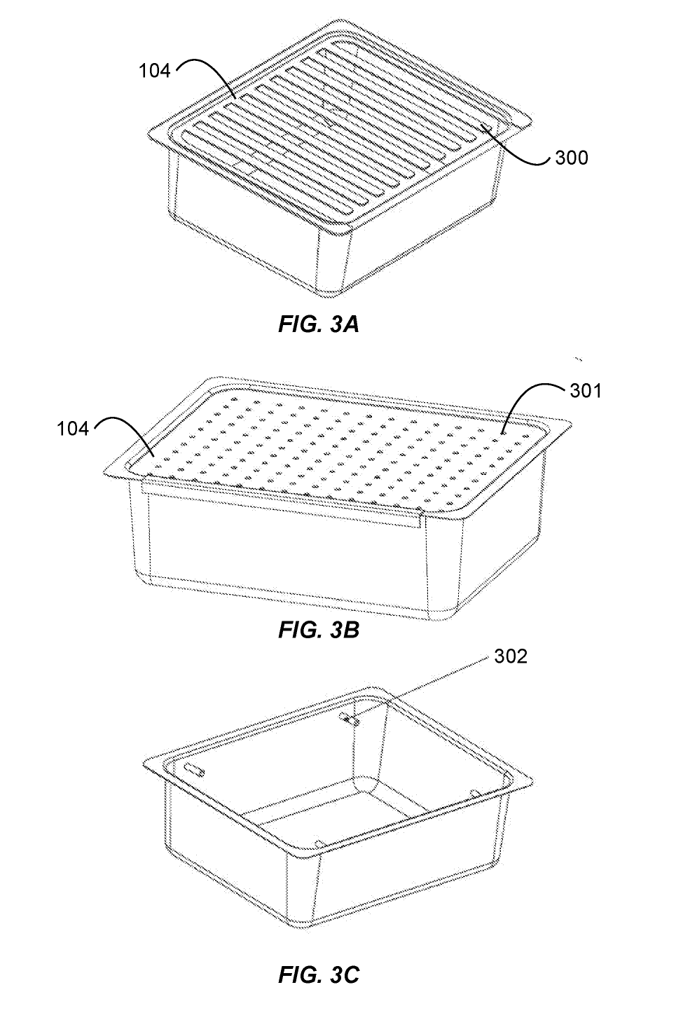

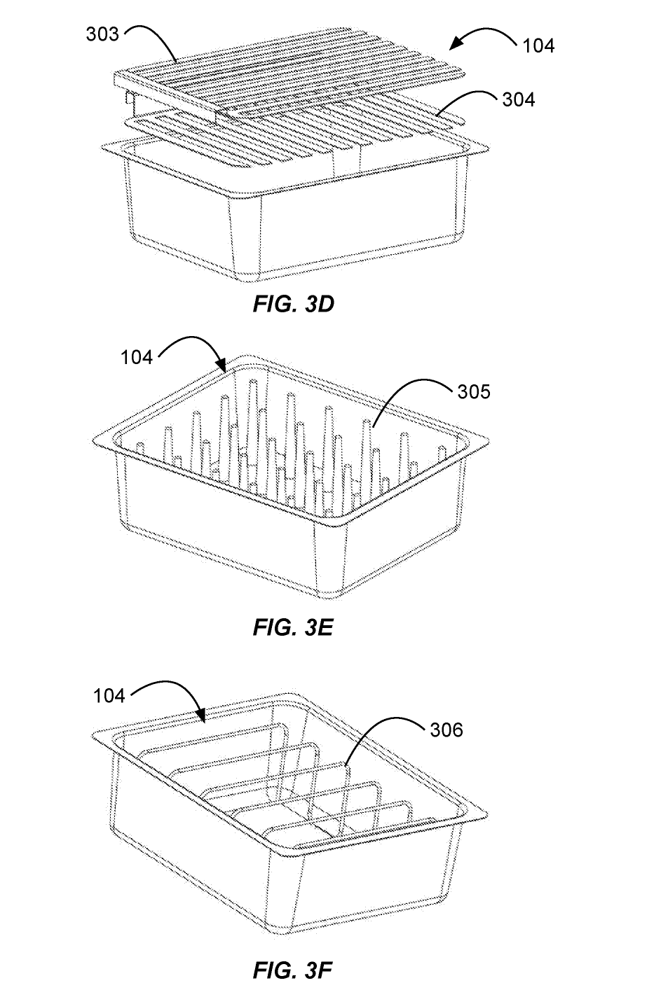

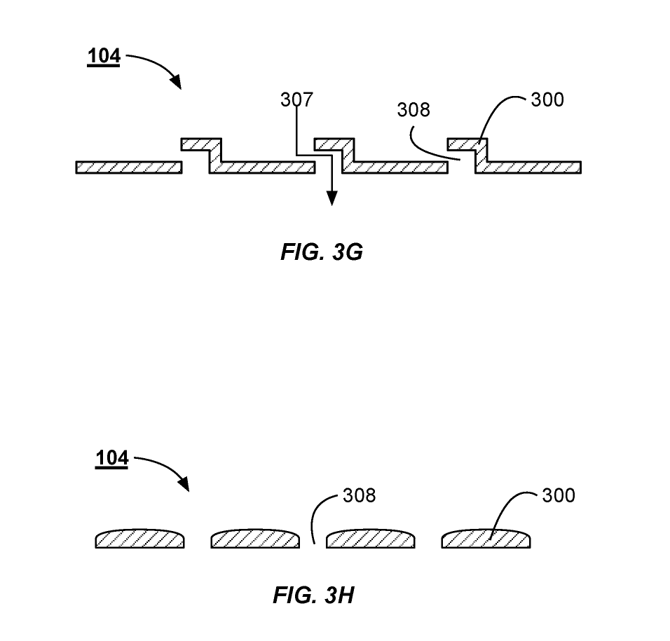

The system 100, as described above in relation to FIG. 1, can also include a support medium 104. The support medium 104 provides support to the pad medium 102. The support medium 104 can enable water to pass to the pad medium 102 and the roots to pass to the water within the vessel 106. The support medium 104 can include support bars, fingers, meshes, and other support structures with differing levels of support. The support medium 104 can be cleaned to remove organic and other matter and reused with subsequent pad mediums 102. FIGS. 3A-3G illustrate different examples of the support medium 104. The support medium 104 can be manufactured from sheet metals, metal wire, plastics, or molded silicone. In some implementations, the system 100 does not include a support medium 104. In these implementations, the pad medium 102 can be held in tension over the vessel 106. For example, the sides of the vessel 106 can include clamps that can maintain tension across the pad medium 102.

FIG. 3A illustrates a support medium 104 with fingers 300. The fingers 300 extend from one side of the support medium 104. The fingers 300 can support the pad medium 102. The spaces between the fingers 300 enable roots to pass through the support medium 104. The extending end of the fingers 300 can be free standing to create open spaces between the fingers, enabling the support medium 104 to be removed from roots of grown plants. One or more edges of the support medium 104 and the free-standing end of the finger can be supported by the vessel 106. The width of the spaces and fingers 300 can be modified for different plants and pad medium 102 configurations. Wider fingers 300 can force more lateral root growth through the pad medium 102 before the roots find a space to grow vertically downward. A stiffer pad medium 102 can enable larger spaces, while a more flexible disposable medium can have narrower spaces. In some implementations, the fingers 300 are spaced between about 0.04 inches and about 2 inches, between about 0.5 inches and about 1.5 inches, or between about 0.5 inches and about 1 inch apart. In some implementations, the spacing of the fingers 300 is dependent on the stiffness of the pad medium 102. For example, a relatively less stiff pad medium 102 can include smaller spaces. In some implementations, the spacing between the fingers 300 is greater than 0.125 inches to avoid pinching the root system of the plant. The support medium 104 can be manufactured from sheet metal via stamping or by the combination of turret punch and press brake. The support medium 104 can also be manufactured in plastic via injection molding.

FIG. 3B illustrates another example support medium 104. The example support medium 104 includes a plurality of holes 301. The diameter of the holes 301 can be between about 0.1 inches and about 0.75 inches, between about 0.1 inches and about 0.5 inches, or between about 0.1 inches and about 0.25 inches. The holes 301 can have a center-to-center spacing between about 0.25 inches and about 1 inch, between about 0.25 inches and about 0.75 inches, or between about 0.25 inches and about 0.5 inches. In some implementations, the support medium 104 with holes 301 is manufactured using a mesh or wire cloth.

FIG. 3C illustrates another example of the support medium 104. In the example illustrated in FIG. 3C, the support medium 104 includes a plurality of posts 302 that extend from the vessel. The posts 302 can support the pad medium 102. In some implementations, the posts 302 are used in combination with pad mediums that include relatively more rigid base layers that can support the pad medium 102.

FIG. 3D illustrates another example support medium 104. The example support medium 104 illustrated in FIG. 3D includes a first layer 303 and a second layer 304. Any of the support mediums described herein can be configured in a multi-layered configuration. A multi-layered support medium 104 can provide additional support to the plant when compared to a support medium 104 with a single layer. In some implementations, multiple layered support mediums are used with larger plants such as tomatoes. The first layer 303 can support the weight of the pad medium 102 and the plant and the second layer 304 can provide support to the plant's roots. The spacing between the first layer 303 and the second layer 304 can be varied to alter the amount of support provided to the plant. For example, a larger relative spacing can provide more support. In some implementations, the support medium 104 can include more than two layers. In some implementations, as is illustrated in FIG. 3D, the openings of the first layer 303 and the second layer 304 are perpendicular to one another to provide additional support for plants. In other implementations, the layers can be configured to include openings that run parallel (or at another angle) to one another.

FIG. 3E illustrates an example support medium 104 that includes a plurality of posts 305. The posts 305 can extend from the floor of the vessel and support the pad medium 102. The posts 305 can be removable or can be a permanent component of the vessel. FIG. 3F illustrates an example support medium 104 that includes a rack 306 with a plurality of ribs that support the pad medium 102. The rack can be made from bending wire to create each of the ribs that crosses the vessel. The rack 306 can be removable or can be a permanent component of the vessel.

FIG. 3G illustrates a cross-sectional view of another example support medium 104. Like the support medium 104 illustrated in FIG. 3A, the support medium 104 includes a plurality of fingers 300. The fingers 300 are separated by a plurality of spaces 308. The spaces 308 are configured in a non-linear 3D forms (or substantially non-straight). The non-linear form of the spaces 308 can cause the roots passing through the support medium 104 to change direction. The roots can follow the path 307. The non-linear path 307 can increase the roots' grip on the support medium 104. The 3D form can be any shape that causes the roots to follow a non-linear path through the support medium 104. For example, the 3D form can be a bend or angle along the depth of the support medium 104, or partial covering of the hole or slot in the support medium 104.

FIG. 3H illustrates a cross-sectional view of another example support medium 104. Like the support medium 104 illustrated in FIG. 3A, the support medium 104 includes a plurality of fingers 300. The fingers 300 are separated by a plurality of spaces 308. As illustrated in FIG. 3H, the upper surface of the fingers 300 are rounded (or otherwise not flat). The shape of the fingers 300 can guide the roots to the open spaces 308 in the support medium 104. In some implementations, the fingers 300 are embossed, stamped, or rolled to generate the rounded surface of the finger 300.

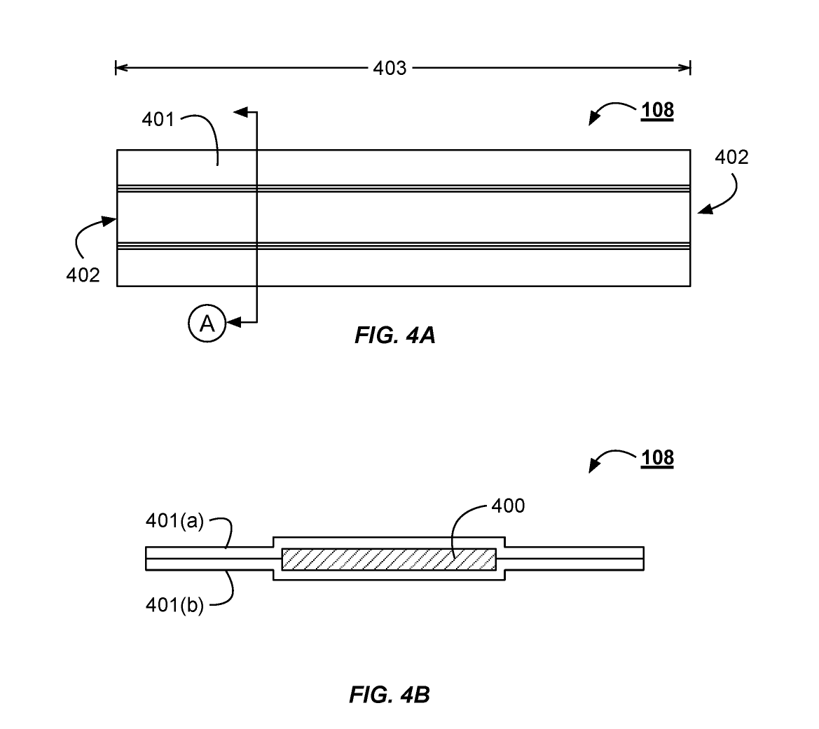

FIG. 4A illustrates a top view of an example nutrient strip 108. FIG. 4B illustrates a cross-sectional and enlarged view of the example nutrient strip 108 illustrated in FIG. 4A made along line A. Referring to FIGS. 4A and 4B together, the nutrient strip 108 includes a nutrient pad 400 that is at least partially enclosed within one or more waterproof layers 401 (also referred to as barrier layers 401). The nutrient strip 108 can automatically release nutrient into the water within the vessel. As discussed above, the nutrient strip 108 can be coupled to the pad medium 102 in such a way as to encounter the water in the vessel. For example, and as illustrated in FIG. 1, the nutrient strip 108 can be configured as a flap of the pad medium 102 that hangs into the water. In this example, the nutrient strip 108 can be separated from the main body of the pad medium 102 by a fold line that enables the nutrient strip 108 to be folded downward. In another example, the nutrient strip 108 can be a separate component that is coupled to the underside of the pad medium 102 or to the vessel 106. In some implementations, the system can include multiple nutrient strips 108. For example, the different nutrient strips 108 can include different nutrients. The different nutrient strips 108 can be placed separately to reduce the formation of insoluble precipitates.

Some seed varieties develop an endosperm that can provide the nutrients for the early stages of plant growth. Once the plant has exhausted the stored nutrients of the endosperm, the seed can use external nutrients that are taken up by the roots. When growing plants hydroponically seeds can be germinated in water with relatively low fertilizer content to maintain an osmotic pressure across the seed to allow the seed to intake water. When the seed has developed enough, it can be watered with higher concentrations of fertilizers. Adding fertilizers too early can prevent or stunt germination, while adding the fertilizers too late can deprive the plant of nutrients and can cause nutrient deficiencies in the growing plant. As described below, the nutrient strip 108 can be configured to release nutrients during key stages of the plant development.

The nutrient strip includes the nutrient pad 400. The nutrient pad 400 can include an absorbent material that wicks water into the nutrient strip 108 and then enables dissolved ions to be released into the water. The absorbent material of the nutrient pad 400 can be made from a pulp-based product such as wood pulp, hemp pulp, or abaca. Because the cellulose fibers in hemp pulp and abaca pulp have longer fibers they can be more resistant to tearing or cracking once dried with salts and other nutrients. The absorbent material could also be made by pressing or blowing pulp in a salt solution instead of water. Pulp can be pressed lightly, so to not remove too much of the solution and then be allowed to dry. Once dry, the pulp will be impregnated with the desired water-soluble nutrients and other chemicals such as algae resistant material or mold resistant material. The pulp can also be blown onto a mesh that is the desired size of the final nutrient pad 400. In some implementations, additional fibers such as cotton fibers, polylactic acid fibers, and nylon fibers can be added to the nutrient pad 400 to increase its strength. In some implementations, the nutrient strip 108 can include multiple nutrient pads 400. The nutrient pads 400 can be stacked upon one another or can be separated by one another by a barrier layer 401 (or portion thereof). The multiple nutrient pads 400 can include the same or different nutrients.

Referring to FIGS. 4A and 4B, as the water contacts the nutrient pad 400 through the openings 402 at either end of the nutrient strip 108. The nutrient pad 400 can wick the water into the nutrient strip 108. The water can begin to dissolve the nutrients of the nutrient pad 400. The dissolved nutrients can then diffuse back through the openings 402 and into the water stored in the vessel. In some implementations, the diffusion of the nutrients can stop when the nutrient concentration in the nutrient strip 108 matches that of the water stored in the vessel.

The nutrient strip's release time, rate of release, and capacity can be controlled by controlling the length 403 of the nutrient strip 108, the size of the openings 402, the number of openings 402, and the shape of the nutrient strip 108. For example, a longer pad 400 can decrease the rate at which the nutrients diffuse into the surrounding water. Examples of the release rates are provided below.

In some implementations, the nutrient pad 400 includes a non-woven absorbent material. In some implementations, non-woven materials can hold more solution when compared to the above-described pulps. The non-woven materials can also be less prone to tearing and cracking once the water-soluble material have dried. Examples of types of non-woven materials can include polylactic acid non-woven materials, polypropylene non-woven materials, and natural fiber non-woven materials.

In some implementations, the nutrient pad 400 can include woven materials. Examples of woven materials can include flax derived cloths like linen, cotton derived cloths like denim, and animal derived cloth like wool fabric.

In some implementations, the nutrient pad 400 can include a gel. The water-soluble materials (e.g., nutrients) can be dissolved in the gel and then the gel can be dried before being encased by the waterproof layers 401. In some implementations, the gel can be encased in the waterproof layers 301 before the gel is dried. The gel can include corn starch, rice starch, potato starch, agar, gum arabic, guar gum, and psyllium.

In some implementations, the nutrient pad 400 can include water-soluble material including, but not limited to, a complete fertilizer either obtained from mineral sources or from organic sources such as compost tea, any subset of the elements for plants either obtained from mineral sources or from organic sources. Support chemicals can be included in the nutrient pad 400. The support chemicals can include chemicals such as silicon, pH regulating chemicals, or any combination of these or any other water-soluble materials. Acids, bases, and buffers in soluble forms can be added to the nutrient pad 400 to regulate the pH of a system over time. These pH regulators can also double as fertilizers as many pH adjusting chemicals already contain essential elements for plants, such as boric acid or calcium bicarbonate. The slow release mechanism may contain fertilizers, pH balancing compounds, or any combination of fertilizers or pH balancing compounds including a mechanism that only contains pH balancing compounds. In some implementations, the water-soluble material can include additives such as starch or agar to help the solution adhere to the nutrient pad 400. The water-soluble material can include glycerin to increase the pliability of the nutrient pad 400. Other additives can be included to slow the movement of dissolved ions through the water, such as polyvinyl acetate, polyvinyl alcohol, and polyethylene glycol.

Still referring to FIGS. 4A and 4B, the nutrient pad 400 is sandwiched between one or more waterproof layers 401. As illustrated in FIG. 4B, the nutrient strip 108 includes an upper waterproof layer 401(a) and a lower waterproof layer 402(b). The waterproof layers 401 create a barrier that enable the nutrient pad 400 to only be exposed to the external environment at the openings 402. The waterproof layers 400 can include a polymer, a wax, or an oil. The polymers can include polypropylene, polyethylene, polystyrene, polyurethane, or biodegradable polymers such as polylactic acid (PLA). The waxes and oils can include paraffin wax, soybean wax, palm oil, and other natural oils and waxes. In some implementations, the waterproof layers 401 can be sprayed onto the nutrient pad 400. The waterproof layers 401 can be generated through hot or cold lamination. For example, the waterproof layers 401 can be manufactured by laminating a thermoplastic around the nutrient pad 400. The laminated thermoplastic can include polylactic acid, polyester, polyethylene, wax, or any other thermoplastic. In some implementations, the waterproof layers 400 are configured to be substantially waterproof for a period of 30 days. In some implementations, the nutrient strip 108 is coupled to a portion of the vessel 106, pad medium 102, or support medium 104. In some implementations, a lining can also be applied on the side facing the nutrient pad 400 that has a lower melting point than the materials of the waterproof layers 401. The lining can act as an adhesive when heated and then cooled such as ethylene vinyl acetate or a wax.

The nutrient strip 108 includes one or more openings 402. The openings 402 can expose the nutrient pad 400 to the external environment. When the nutrient strip 108 is in contact with water (or other liquid), the openings 402 can enable water to enter the nutrient strip 108 and diffuse into the nutrient pad 400. The nutrients embedded within the nutrient pad 400 can defuse out of the nutrient strip 108. The nutrient pad 400 can be impregnated with fertilizers components, in the form of salts, such as potassium nitrate, magnesium sulfate, and calcium nitrate. The nutrient strip 108 can be configured to release different amounts of nutrients at different time points to make the development of the plants. For example, when a plant is undergoing vegetative growth (when they are growing leaves, roots, and stems) the plants can benefit from fertilizers high in nitrogen. When a plant starts to bloom, or produce fruit, the plant can benefit from a relatively higher amount of phosphorous. An excess of nitrogen while the plant is blooming might decrease the yield of the fruit as the plant will continue to produce leaves and vegetative matter instead of focusing energy on producing fruit.

In some implementations, the nutrient strip 108 is configured to release nutrients over time. The nutrient strip 108 can begin to release nutrients once in contact with water. As discussed above, too much nutrients during the germination stage can be detrimental to the seed. The nutrient strip 108 can release nutrients into the water of the system 100 at an initially slow rate such that during the germination stage, the concentration of nutrients is at a level that does not affect germination. By the time the plant passes the germination stage, the nutrients are at a beneficially high level for supplying nutrients to the plant.

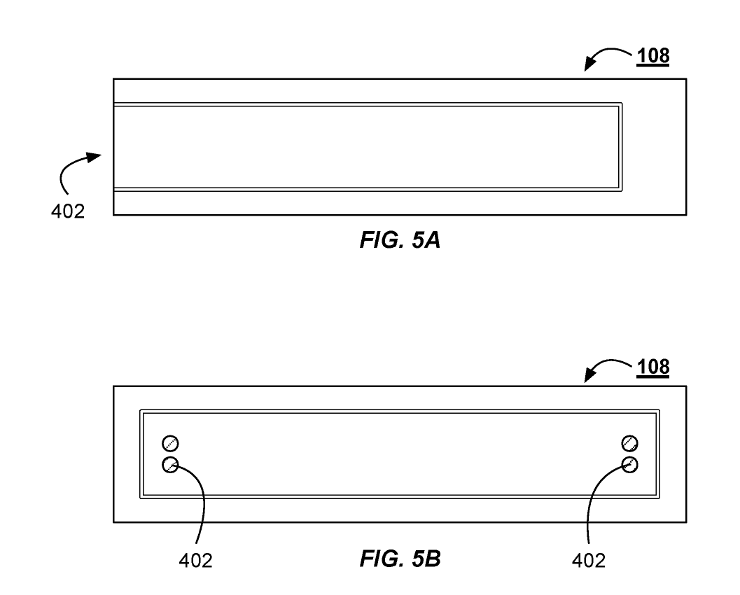

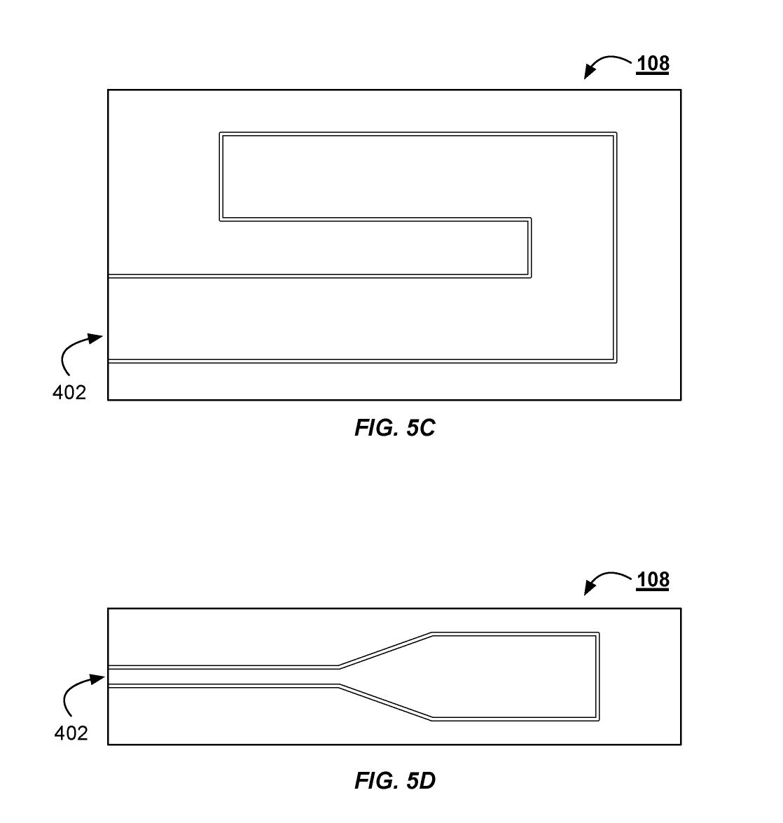

FIGS. 5A-5D illustrate example configurations of the nutrient strip 108. FIG. 5A illustrates a top view of an example nutrient strip 108 with a single opening 402. FIG. 5B illustrates a top view of an example nutrient strip 108 with multiple openings 402. Rather than openings at the end of the nutrient strip 108, the openings 402 of the nutrient strip 108 illustrated in FIG. 5B are circular openings in a face of the waterproof layers 401. In some implementations, the openings 402 can be formed along the length of the waterproof layers to expose multiple portions of the nutrient pad 400 to the environment. The openings 402 can each be of the same or different size. The openings 402 can be configured as slits in the waterproof layers or have non-circular shapes.

FIG. 5C illustrates a top view of an example nutrient strip 108 with a serpentine nutrient pad (or non-straight). As illustrated the nutrient strip 108 includes a single opening 402. The nutrient pad housed within the nutrient strip 108 is serpentine in shape to increase the length of the nutrient pad without increasing the overall length of the nutrient strip 108.

FIG. 5D illustrates a top view of an example nutrient strip 108 with a nutrient pad with a varying shape along its length. As discussed in the below examples, the shape of the nutrient pad and the size of the cross-sectional area of the nutrient pad exposed to the environment can control the rate of nutrient release from the nutrient pad. Varying the shape of the nutrient pad over its length enables the nutrient strip 108 to release different amounts of nutrients at different time periods. As illustrated in FIG. 5D, towards the opening 402, the nutrient pad is relatively narrow and then widens along the length of the nutrient strip 108. In some implementations, the width, height, or cross-sectional area of the nutrient pad changes along the length of the nutrient pad. As described herein, the system can include multiple nutrient strips 108 or nutrient strips 108 with multiple nutrient pads 400. The different nutrient strips 108 or multiple nutrient pads 400 can include different nutrients. The nutrient strips 108 or multiple nutrient pads 400 can be shaped differently from one another such that the nutrients from the different nutrient strips 108 or multiple nutrient pads 400 are released at different rates.

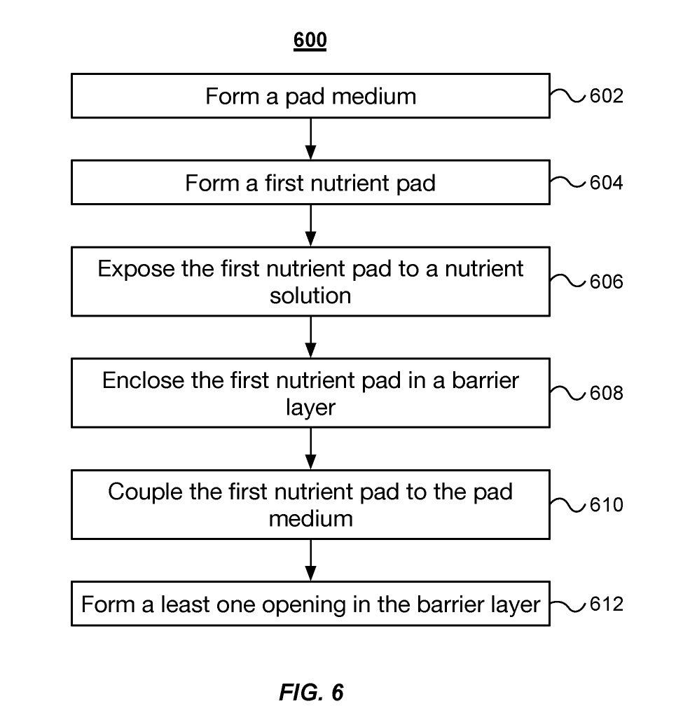

FIG. 6 illustrate a flow diagram of an example method 600 for manufacturing the system described herein. The method 600 includes forming a pad medium (step 602). The method 600 also includes forming a first nutrient pad (step 604). The first nutrient pad can be exposed to a nutrient solution (step 606). The first nutrient pad can be enclosed in a barrier layer (step 608). The first nutrient pad can be coupled to the pad medium (step 610). The method 600 can also include forming at least one opening in the barrier layer (step 612).

As set forth above, the method 600 can include forming a pad medium (step 602). The pad medium can be any of the pad mediums described herein. In some implementations, the pad medium is a multi-layer medium that includes a plurality of seeds. In some implementations, the pad medium can be manufactured in a continuous manufacturing process. For example, and also referring to FIG. 2A, the method can include feeding, from a roll, a base layer 204 material beneath an automatic seeder. Example automatic seeders are described below. The automatic seeder can deposit the seeds (at a predetermined density) onto a top surface of the base layer. In some implementations, a gel layer can be applied to the base layer to help the seeds adhere to the base layer. From a second roll, the top layer 200 material can be guided to meet the base layer 204 after seeds are deposited onto the base layer 204. Alternatively, if the top layer 200 is a sprayable material, the top layer 200 can be sprayed onto the base layer 204 over the seeds. In some implementations, the pad medium can include additional layers.

The method 600 can also include forming a first nutrient pad (step 604). The nutrient pad material can be dispensed from a roll. In some implementations, forming the nutrient pad can include shaping the nutrient pad. For example, the nutrient pad can be cut with rolling cutters to a specific width.

The method 600 can also include exposing the first nutrient pad to a nutrient solution (step 606). For example, the nutrient pad material can travel from the roller through one or more vats of nutrient-rich water. In some implementations, the method 600 can include forming multiple nutrient pads, and each of the multiple nutrient pads can travel through different vats of nutrient-rich water. The nutrients in each of the vats can be different. After traveling through the vat, the nutrient pad material can be dried with, for example, a convective dryer. The dryer can dry off the water, leaving the nutrients in the nutrient pad. In some implementations, the nutrient pad can be exposed to the nutrient solution by spraying the nutrient solution onto the nutrient pad. In some implementations, the nutrients are in a solid form, such as in a salt form, and can be deposited onto (or in) the nutrient pad.

The method 600 can also include enclosing the first nutrient pad in a barrier layer (step 608). In some implementations, the first nutrient pad is enclosed in the barrier layer to form a nutrient strip. In some implementations, the first nutrient pad is only partially enclosed in the barrier layer. For example, the barrier layer can include one or more openings or the barrier layer can be applied to only a single surface of the first nutrient pad. The barrier layer can be dispensed from a roller and can meet with the nutrient pad after the nutrient pad is at least partially dried.

The method 600 can also include coupling the first nutrient pad to the pad medium (step 610). The nutrient pad material and the barrier layer material can meet the base layer of the pad medium at sealing rollers which can couple the barrier layer to the nutrient pad and the nutrient pad (or another barrier layer) to the base layer of the pad medium. The sealing rollers can press and couple the top layer with the base layer of the pad medium. In some implementations, the sealing rollers can apply heat and pressure to seal the layers together. In some implementations, the layers can be coupled together with an adhesive. In some implementations, the nutrient strip and the pad medium can be manufactured in separate processes, and the nutrient strip can be coupled to the nutrient pad after the pad medium is manufactured.

The method 600 can also include forming at least one opening in the barrier layer (step 612). In some implementations, after formed into a single, multi-layer piece, a rotary die cutter can cut the continuous pad medium sheet and coupled nutrient strip into suitable shapes. In some implementations, the openings in the barrier layer can be the exposed ends of the nutrient pad that are generated when the rotary die cutter cuts the continuous pad medium sheet and coupled nutrient strip. During this process, the length of the nutrient strip can also be controlled, changing the nutrient release qualities. In some implementations, the rotary die can cut, perforate, or scrap a portion of the water-proof material such that, for each complete pad medium, a portion of the nutrient pad 400 is exposed to the external environment.

In some implementations, the above-described automatic seeder can be a drum seeder. The drum seeder can operate continuously. The drum seeder can include a rotating drum with holes drilled around its periphery. The holes have a diameter smaller than the diameter of the seeds. The holes are coupled to a vacuum, such that a vacuum is generated at each of the holes. Seeds, in a hopper, can be oscillated with a linear guide vibrator against the drum. As the drum rotates, the holes of the drum come into contact with the seeds. The vacuum generated at each of the respective holes draws a seed against the respective hole. A blast of compressed air from nozzles can remove double seeds. When the seeds reach the bottom of the drum, low pressure air can eject the seed from the hole. A scraper blade can ensure the seed is dropped onto the base layer moving beneath the rotating drum. The rotation of the drum can be electronically or mechanically synchronized with the movement of the base layer.

In some implementations, the automatic seeder can be a row seeder. The row seeder can include a row of actuated, pneumatic cylinders. The cylinders can swing between a hopper to collect a seed and then swing over the base layer to drop the seed onto the base layer.

In some implementations, the seeds can be randomly applied to the pad medium. For example, the seeds can be placed in a hopper with a number of holes in the bottom of the hopper. A vibrator can vibrate the hopper, causing seeds to fall through the holes onto the base layer. The number and holes in the bottom of the hopper can be changed to alter the seed density in the pad medium.

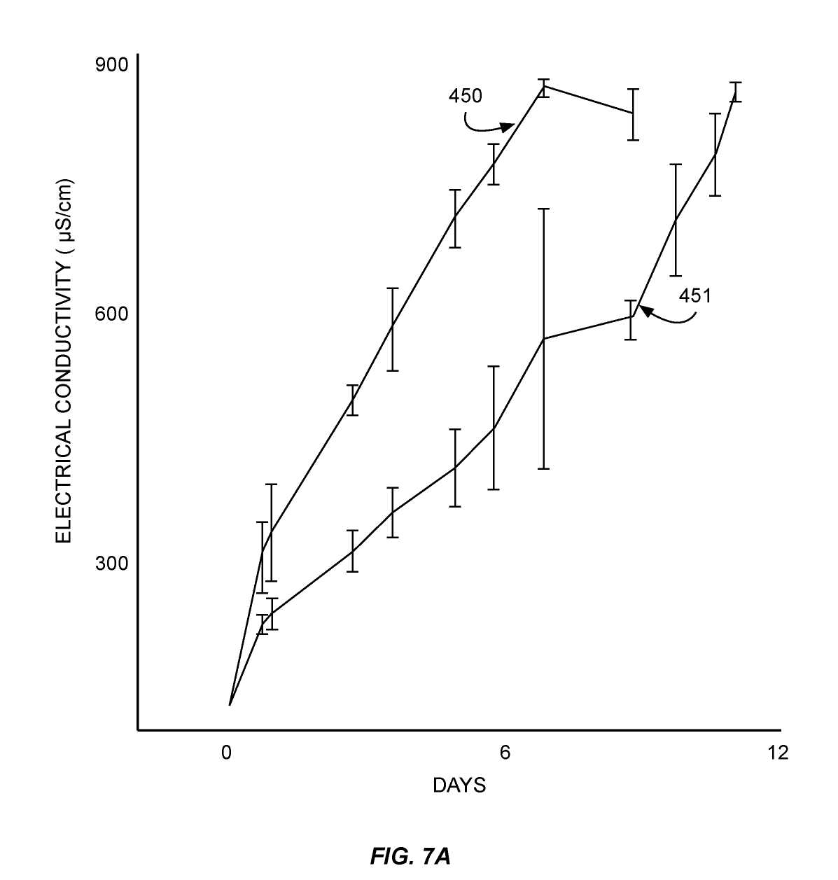

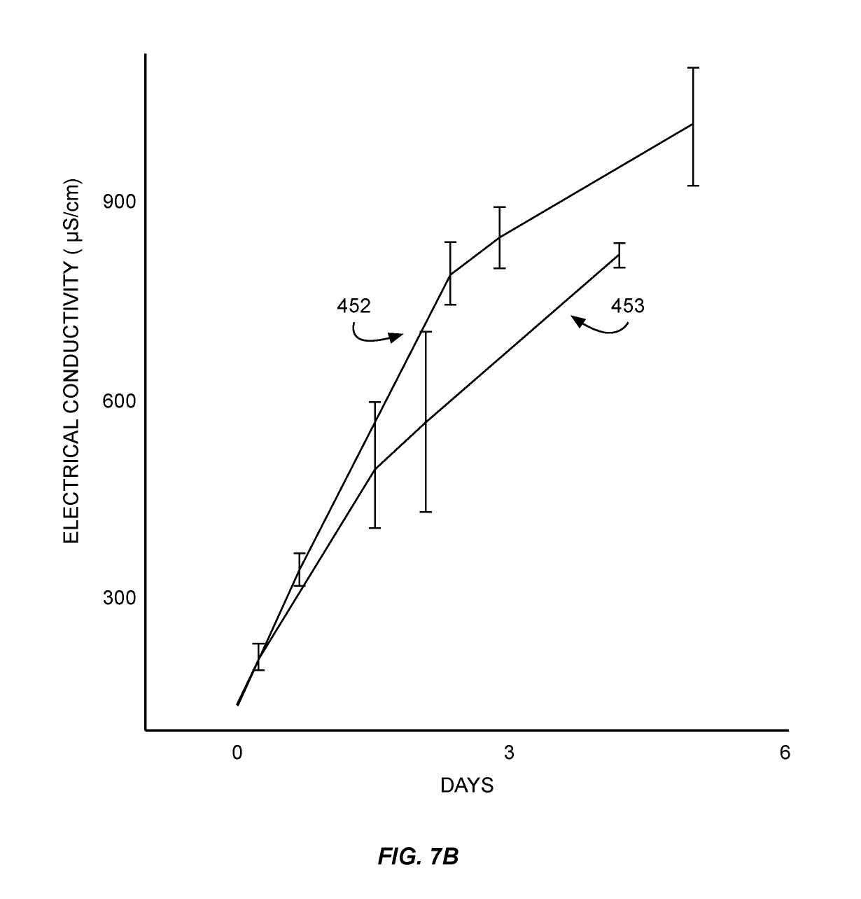

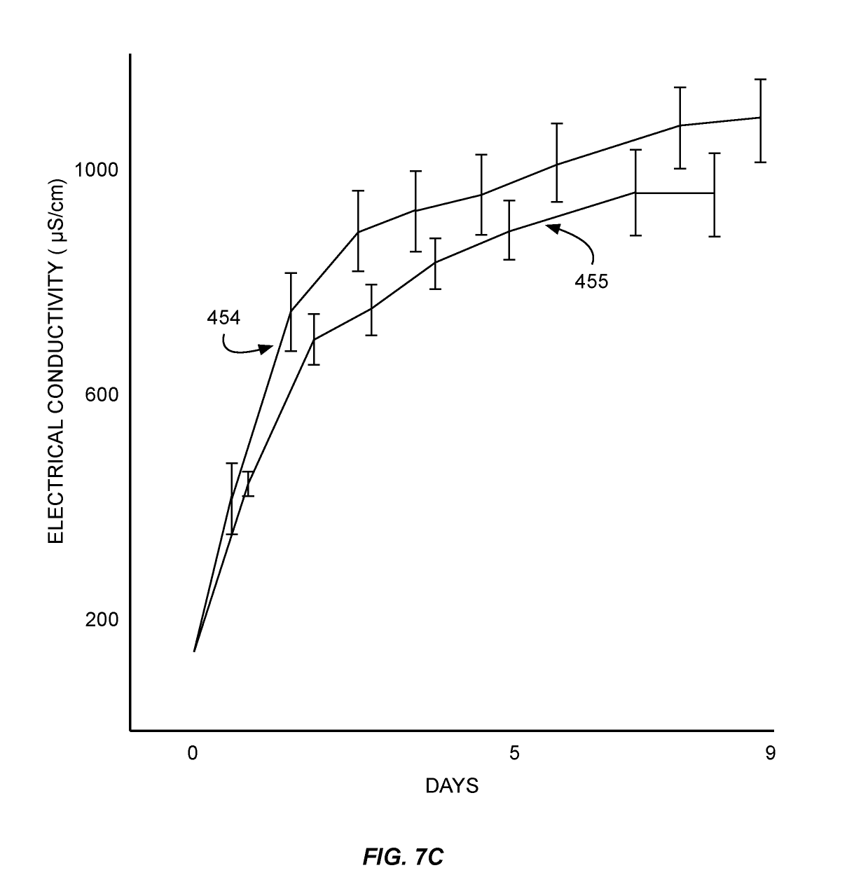

FIG. 7A illustrate a plot of nutrient strip release rate (as measured by the water's electrical conductivity). Line 450 plots the release time of a 15 cm long nutrient strip 108 and line 451 plots the release time of a 20 cm long nutrient strip 108. Each nutrient strip 108 had a total of 5.0 g of water-soluble material in the pad, each pad had a width of 2.0 cm, and was 0.21 mm thick. The strips were floating in a reservoir with 5 L of water with an initial electrical conductivity of 140 μS/cm. The plot illustrates that both configurations eventually reach the same electrical conductance level; however, the release rate of the 15 cm long nutrient strip 108 is quicker when compared to the 20 cm long nutrient strip 108.

FIG. 7B illustrate a plot of nutrient strip release rate for pads of different thicknesses. Changing the thickness of the pad can result in a greater exposed surface area of the pad at the openings 402. A thicker pad can increase the rate at which the water-soluble material can diffuse into the surrounding water. FIG. 7B illustrates the difference in release rate in two types of nutrient strip 108 that differ only in thickness of the pad. Plot 452 was generated by a nutrient strip 108 with a pad thickness of 0.28 mm. Plot 453 was generated by a nutrient strip 108 with a pad thickness of 0.21 mm. Each nutrient strip 108 included total of 5.0 g of water-soluble material in the pad, each strip had a width of 2.0 cm, and a length of 20 cm. The nutrient strips were floating in a reservoir with 5 L of water with an initial electrical conductivity of 140 μS/cm.

FIG. 7C illustrate a plot of nutrient strip release rate for pads of different widths. Changing the width of the pad can result in a greater exposed surface area of the pad at the openings 402. A wider pad can increase the rate at which the water-soluble material can diffuse into the surrounding water. FIG. 7C illustrates the difference in release rate in two types of nutrient strip 108 that differ only in width of the pad. Plot 454 was generated by a nutrient strip 108 with a pad width of 2 cm. Plot 455 was generated by a nutrient strip 108 with a pad width of 1.5 cm.

As used herein, the term “about” and “substantially” will be understood by persons of ordinary skill in the art and will vary to some extent depending upon the context in which it is used. If there are uses of the term which are not clear to persons of ordinary skill in the art given the context in which it is used, “about” will mean up to plus or minus 10% of the particular term.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of,” “Consisting essentially of,” when used in the claims, shall have its ordinary meaning as used in the field of patent law.

As used herein in the specification and in the claims, the phrase “at least one” in reference to a list of one or more elements should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03

It will be apparent to those skilled in the art that various modifications and variations can be made in the methods of the present invention without departing from the spirit or scope of the invention. Thus, it is intended that the present invention cover the modifications and variations of this invention provided they come within the scope of the appended claims and their equivalents. All publicly available documents referenced herein, including but not limited to U.S. patents, are specifically incorporated by reference.

What is claimed:

1. A hydroponic system comprising:
a pad medium comprising a plurality of seeds;
a first nutrient strip coupled to the pad medium, the first nutrient strip comprising:
a first nutrient pad impregnated with nutrients, and
a barrier layer at least partially enclosing the first nutrient pad, the barrier layer having an opening to expose the first nutrient pad to an external environment, a shape of the first nutrient pad and a shape of the opening configured to control a rate of release of nutrients from the first nutrient strip.

2. The system of claim 1, further comprising:
a vessel; and
a support medium comprising a plurality of openings to enable roots from the plurality of seeds to pass through the support medium and into the vessel.

3. The system of claim 2, wherein the plurality of openings comprises a non-linear form that cause the roots from the plurality of seeds to change direction as they pass through the support medium and into the vessel.

4. The system of claim 1, wherein the shape of the first nutrient pad changes over a length of the first nutrient strip.

5. The system of claim 1, wherein the first nutrient pad comprises one of a woven material, a polylactic acid non-woven material, a polypropylene non-woven material, or a natural fiber non-woven material.

6. The system of claim 1, wherein the first nutrient pad comprises a dried gel comprising at least one of corn starch, rice starch, potato starch, agar, gum arabic, guar gum, algae resistant material, mold resistant material, or psyllium, wherein the nutrients are dissolved in the gel.

7. The system of claim 1, comprising a second nutrient strip comprising a second nutrient pad impregnated with nutrients different than the nutrients impregnated in the first nutrient pad.

8. The system of claim 1, wherein the nutrients comprise at least one of a water-soluble fertilizer and support chemicals comprising at least one of silicon, algae resistant material, mold resistant material, or pH regulating chemicals.

9. The system of claim 1, wherein the first nutrient strip is configured to release the nutrients to the external environment after the seeds substantially exhaust the stored nutrients in an endosperm of each of the plurality of seeds.

10. The system of claim 1, wherein a cross-sectional area of the first nutrient pad changes along the length of the first nutrient pad.

11. A hydroponic nutrient strip comprising:
a first nutrient pad impregnated with nutrients, and
a barrier layer at least partially enclosing the first nutrient pad, the barrier layer having an opening to expose the first nutrient pad to an external environment, a shape of the first nutrient pad and a shape of the opening configured to control a rate of release of nutrients from the first nutrient pad into the external environment.

12. The hydroponic nutrient strip of claim 11, wherein the shape of the first nutrient pad changes over a length of the first nutrient strip.

13. The hydroponic nutrient strip of claim 11, wherein the first nutrient pad comprises one of a woven material, a polylactic acid non-woven material, a polypropylene non-woven material, or a natural fiber non-woven material.

14. The hydroponic nutrient strip of claim 11, wherein the first nutrient pad comprises a dried gel comprising at least one of corn starch, rice starch, potato starch, agar, gum arabic, guar gum, algae resistant material, mold resistant material, or psyllium, wherein the nutrients are dissolved in the gel.

15. The hydroponic nutrient strip of claim 11, comprising a second nutrient pad impregnated with nutrients different than the nutrients impregnated in the first nutrient pad.

16. The hydroponic nutrient strip of claim 11, wherein the nutrients comprise at least one of a water-soluble fertilizer and support chemicals comprising at least one of silicon, algae resistant material, mold resistant material, or pH regulating chemicals.

17. The hydroponic nutrient strip of claim 11, wherein a cross-sectional area of the first nutrient pad changes along the length of the first nutrient pad.

18. A method for manufacturing a hydroponic system, the method comprising:
forming a pad medium by:
depositing a plurality of seeds onto a base layer;
depositing a top layer on the base layer and the plurality of seeds;
forming a first nutrient pad into a shape configured to control a rate of release of nutrients from the first nutrient pad;
exposing a first nutrient pad to a nutrient solution;
at least partially enclosing the first nutrient pad in a barrier layer;
coupling the first nutrient pad to the pad medium;
forming at least one opening in the barrier layer to the expose a portion of the first nutrient pad to an external environment, wherein a shape of the at least one opening is configured to control the rate of release of nutrients from the first nutrient pad.

19. The method of claim 18, wherein the shape of the first nutrient pad changes over a length of the first nutrient strip.

20. The method of claim 18, wherein the first nutrient pad comprises one of a woven material, a polylactic acid non-woven material, a polypropylene non-woven material, or a natural fiber non-woven material.
